(19) United States
(12) Patent Application Publication
(10) Pub. No.: US 2025/0229979 A1
(43) Pub. Date: Jul. 17, 2025

(54) FREIGHT CONTAINER DOOR MOTION SENSOR MONITOR

(71) Applicant: ArrowSpot Systems Ltd., Kfar Hess (IL)

(72) Inventors: Ran Menachem GRINSHTAIN, Kfar Hess (IL); Shahar GINO, Haifa (IL); Vadim KAZAIS, Herzliya (IL); Moshe SADERO, Kohav Yair (IL)

(21) Appl. No.: 19/014,082

(22) Filed: Jan. 8, 2025

Related U.S. Application Data
(60) Provisional application No. 63/619,821, filed on Jan. 11, 2024.

(51) Int. Cl. B65D 90/48; B65D 90/00; G01P 13/00

(52) U.S. Cl. CPC B65D 90/48; B65D 90/008; G01P 13/00

(57) ABSTRACT

A device is provided for monitoring door-opening and door-closing events on a freight container. The device includes a motion sensor, a communications transmitter, and a processor configured to perform steps that include: receiving motion signals generated by the motion sensor; processing the signals by a trained signal processing model, trained to identify door-opening and door-closing events; responsively identifying likely door-opening or door-closing events; and responsively to identification of a likely door-opening or door-closing events, transmitting an alert indicating the event.

### CROSS REFERENCES TO RELATED APPLICATIONS

This application claims the benefit under 35 U.S.C. § 119(b) to U.S. Provisional Patent Application No. 63/619,821, filed Jan. 11, 2024, hereby incorporated by reference.

### FIELD OF THE INVENTION

The present invention relates to the field of freight tracking, and particularly to the monitoring of freight container doors.

### BACKGROUND

More than a billion tons of goods are transported in freight containers each year, over both land and sea. Increasingly, operators who provide freight container transport, as well as their customers, are interested in tracking the condition of their assets when in transit and in storage. Modern cargo monitoring services include a range of services, such as monitoring of container location, cargo temperature and humidity, intrusion detection, container shocks, and door opening. Detection of door opening is typically determined by monitoring light in a container, but such a method has disadvantages, such as low accuracy at night or when the sensor is dirty. Similarly, a light sensor on mounted to the external wall of a container can detect light inside the container only if a hole is drilled under the light sensor.

More reliable door monitoring could improve insight into transit and storage problems, reducing costs and improving cargo company service.

### SUMMARY

Embodiments of the present invention provide a device and methods for a motion sensor-based freight container monitor for identifying vibration patterns that identify opening and closing of a freight container door. A monitor configured to be mounted on a freight container door or elsewhere on a freight container includes one or more motion sensors, such as an accelerometer and/or microphone. Signals generated by the motion sensor are processed by signal processing techniques, such as a machine learning neural network, to determine the door-opening and door-closing events.

### BRIEF DESCRIPTION OF DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice. In the accompanying drawings:

FIG. 1 is a view of a door monitor for identifying door opening, mounted on a freight container door, according to some embodiments of the invention;

FIG. 2 is a block diagram of components of the door monitor, according to some embodiments of the invention;

FIG. 3 is a graph of exemplary motion sensor signals received by a processor of the door monitor, according to some embodiments of the invention;

FIGS. 4A and 4B are schematic diagrams of processes of training and applying a machine learning (ML) engine for detecting door-opening and closing events, according to some embodiments of the invention;

FIG. 5 is a flowchart of a process of applying a hybrid ML engine for detecting door-opening and closing events, according to some embodiments of the invention;

FIG. 6 is a schematic diagram of a rule-based model implemented within the hybrid ML engine for detecting door-opening and closing events, according to some embodiments of the invention;

FIG. 7 is a schematic diagram of a neural network model implemented within the hybrid ML model for detecting door-opening and closing events, according to some embodiments of the invention; and

FIG. 8 is a graph of exemplary signals received and generated by a processor of the door monitor, according to some embodiments of the invention.

### DETAILED DESCRIPTION

In the following description, various aspects of the present invention are described. For purposes of explanation, specific configurations and details are set forth in order to provide a thorough understanding of the present invention.

It will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Detecting the opening of a freight container door is important to detect possible theft and to prevent spoilage of cargo in refrigerated containers. Similarly, detection of door closure is important to confirm that an open door condition has been corrected. The present invention provides a “container door monitor” for remotely monitoring when a door is opening or closed.

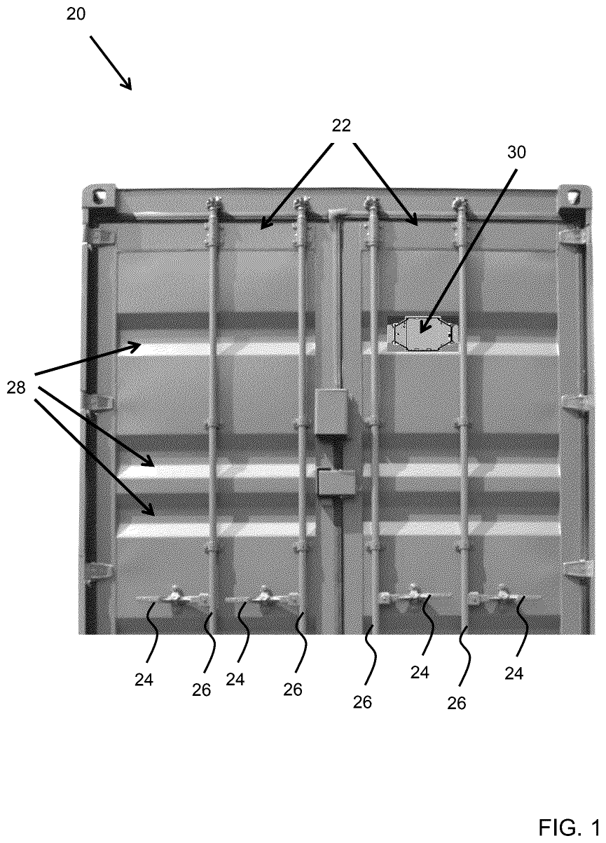

FIG. 1 is a rear view of a typical freight container 20 used for multimodal transport, i.e., for transport by both ships and trucks, having doors 22. The doors are kept securely closed by locking handles 24, which fit into retainers in the doors. Releasing the locking handles rotates locking bars 26 out of their cam keepers, which frees the locking bars so that the doors 22 can be opened. As described below, the motion of the locking handles during the opening and closing of the freight container doors causes vibrations, and consequently sounds, which can be sensed by motion sensors such as accelerometers and microphones.

The doors are typically corrugated to provide strength, with the exemplary doors in the figure showing three corrugated recesses 28. Also shown is a door monitor 30, which may be configured to be mounted in a corrugated recess of one of the doors and described further hereinbelow. Alternatively, the door monitor, also referred to herein as a detector system, may be configured to be placed elsewhere on or inside the freight container.

As described below, the detector system detects container events that indicate “door-opening events,” i.e., opening of the door, and “door-closing events,” i.e., closing of the door. Detection is achieved by processing of signals generated by one or more motion sensors of the detector system. The system may be designed to operate in the harsh conditions that characterize container usage and transport.

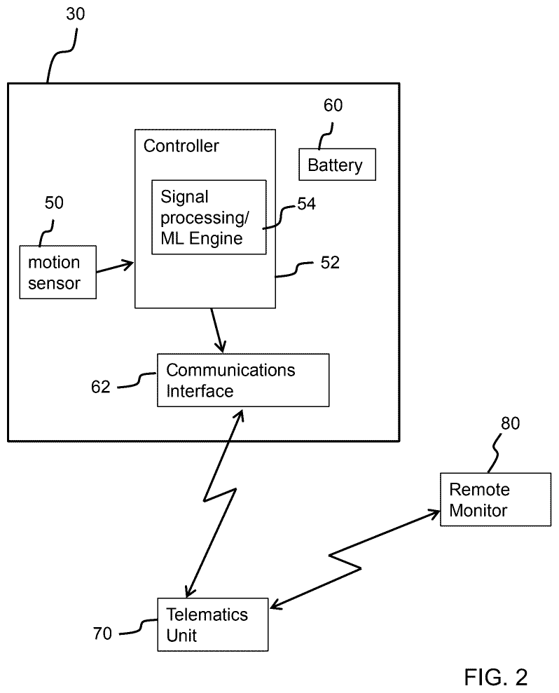

FIG. 2 is a block diagram of components of the door monitor 30. As indicated in the diagram, the door monitor 30 includes a motion sensor 50. The motion sensor may be, for example, a 3-axis (X,Y,Z) accelerometer, and/or a microphone configured to detect sounds generated by motion, i.e., by vibrations, and/or other motion sensors known in the art. The motion sensor sends signals (such as 3-axis accelerometer signals or other electrical signals) to a controller 52, which is programmed to receive and to process the signals. Controller 52 may be any type of programmable processor, such as a microcontroller, that is configured for stand-alone operation and which is typically configured to fit in a confined space of a casing of the door monitor 30.

A signal processor, such as a machine learning (ML) engine 54 executed by the processor, as described further hereinbelow, may be configured to determine whether signals received during each of successive windows of time (such as seconds, tenths of seconds, or less) are indicative of a door-opening or door-closing event. Typically, the door monitor is a self-contained, self-powered device designed for extended, continuous operation, which may be powered by a battery 60. That is the battery, processor, and motion sensor of the system may be provided in a single unit, such as a single unit configured for minimal protrusion on a freight container door or wall. Alternatively, the components may be provided in distinct, separate units. In a powered container, such as a refrigerated freight container (i.e., “reefer”), the system may be mounted to receive power from the container power supply (e.g., from the container fuse box).

When self-powered, the system controller is typically operated in a low-energy mode, which may be triggered by signals received from the motion sensor to process input. In addition, the ML engine 54 may be designed to provide efficient power usage while maintaining a preset level of accuracy. For example, a critical success index (CSI), also referred to as a “threat score,” may be set to a minimum of 85%, where the CSI is measured as a ratio between true positives to the overall number of cases. Power efficiency is also improved by operating with a wake-up trigger, based on the motion sensor signal.

When either a door-opening or door-closing event is detected, as described further hereinbelow, the controller 52 issues an alert that a door-opening or door-closing event has occurred (that is, that there is a prediction, having a high probability of likelihood, that such an event has occurred). The alert may be issued as an electronic signal, transmitted in a wired or wireless manner, to a local or remote operator, such as an operator in an area near where the freight container with the door monitor is located. Typically, the door monitor transmits, by a communications interface 62, an alert signal to an external telematics unit 70 that may be co-located or built into the door monitor, or installed separately on the freight container on which the given freight container is placed. The telematics unit may be configured to wirelessly transmit the door-opening and door-close signals, as well as other signals from other container monitoring devices, by remote transmission protocols known in the industry, such as cellular or satellite communications. The transmission may be directed to a monitor 80, such as remote device accessible by a freight operator or freight customer. Transmission of the signal from the telematics unit 70 to the remote monitor 80 may include multiple transmission steps, such as transmission by satellite and/or over the internet.

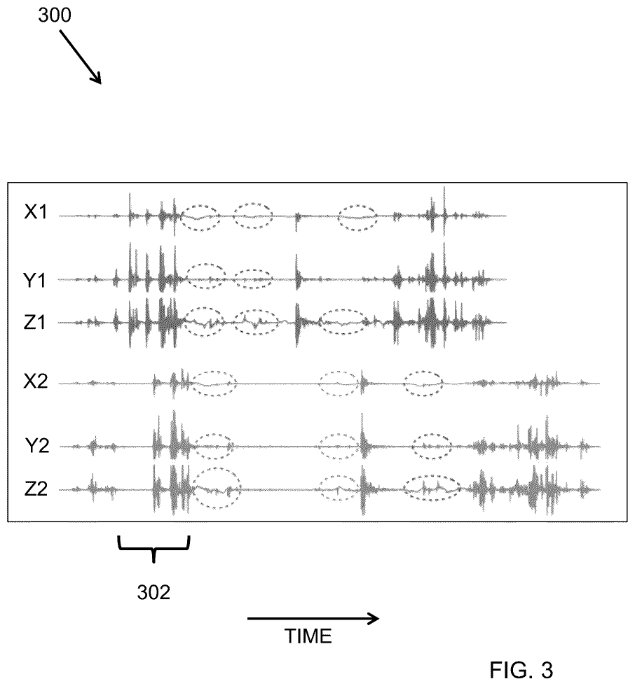

FIG. 3 is a graph 300 of exemplary signals generated by the motion sensor 50 and received by the controller 52 of the door monitor, as described above. The figure shows two sets of examples of 3-axis (X, Y, Z) motion sensor signals (e.g., accelerometer recordings). As described above, alternative or additional motion sensor signals may also be provided.

Each set of signals shows the signals transmitted from the motion sensor in parallel. The dashed ellipses overlapping the signals indicate the time of actual open- or close-door events. As can be seen in the graph, vibrations that are indicative of moving the locking handles, such as the vibrations indicated in a time window 302, may precede the door-opening events and/or may follow the door-closing events. However, there are other causes of large vibrations that are unrelated to door opening and door closing, such as movement and loading of a container. The ML engine (i.e., signal processor) is trained to correlate the vibrations in time windows before, during, and after door-opening and door-closing events, in order to distinguish vibrations related to these events from other vibrations and to issue alerts related specifically to door-opening and door-closing events. As described above, the motion sensor may also include additional or alternative motion sensor technologies, such as a microphone that senses mechanical vibrations that generate sound, with the ML engine similarly trained to identify the signal patterns from the additional or alternative technologies.

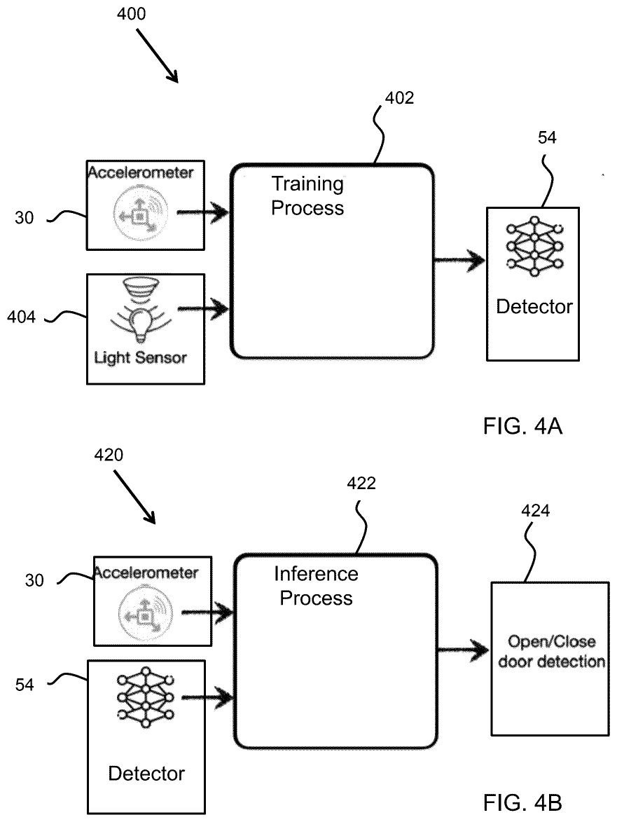

FIGS. 4A and 4B are schematic diagrams of processes of training the machine learning (ML) engine 54 (indicated with respect to FIG. 2) for detecting door-opening and closing events and of subsequently applying the trained engine. During a training phase 400, a supervised training process 402 receives signals, such as those indicated in FIG. 3, from the motion sensor 30 (e.g., an accelerometer) and from a light sensor 404 that is positioned in a container and provides signals indicative of actual open and close door events (the light sensor indicating “ground truth”). The correlation between motion signals and open and close door events is used to generate the ML-engine (i.e., “detector”) 54, which may be based, for example, on a neural network. As described below, the correlation may alternatively or additionally be performed by a signal processor implementing a “shallow” signal processing algorithm. It is understood that methods known in the art may be used to synchronize the accelerometer and light sensor signals, such as using timestamp alignment with interpolation to handle different sampling rates. The light sensor 404 generally has a sampling rate at least as high as the accelerometer to avoid missing brief door events. The ML-engine 54 is generally optimized for embedded deployment. Methods known in the art include quantizing the trained model to reduce memory footprint and improve inference speed. Fixed-point arithmetic is applied where possible to reduce computational overhead, including use of circular buffers for storing a rolling window of sensor data, as well as the use of optimized libraries for microcontroller neural network operations.

During a subsequent prediction phase 420 (also referred to herein as an inference phase), an inference process 422 applies the detector 54 to new signals received from the motion sensor 30 to make open/close door detection predictions 424. As described further hereinbelow, the ML-based detector 54 may be a “deep” neural network model, and its results may be merged with results of a rules-based model (a “shallow” model), to provide a hybrid detector ML engine that improves energy efficiency and memory usage, enabling the detection to be implemented in a compact unit such as the door monitor, intended for mounting on a freight container. Ensemble combinations of deep and shallow algorithms have been applied in other field, such as sentiment analysis, as described by Nguyen et al., in “An Ensemble of Shallow and Deep Learning Algorithms for Vietnamese Sentiment Analysis,” 2018 5th NAFOSTED Conference on Information and Computer Science (NICS), 2018, pp. 165-170.

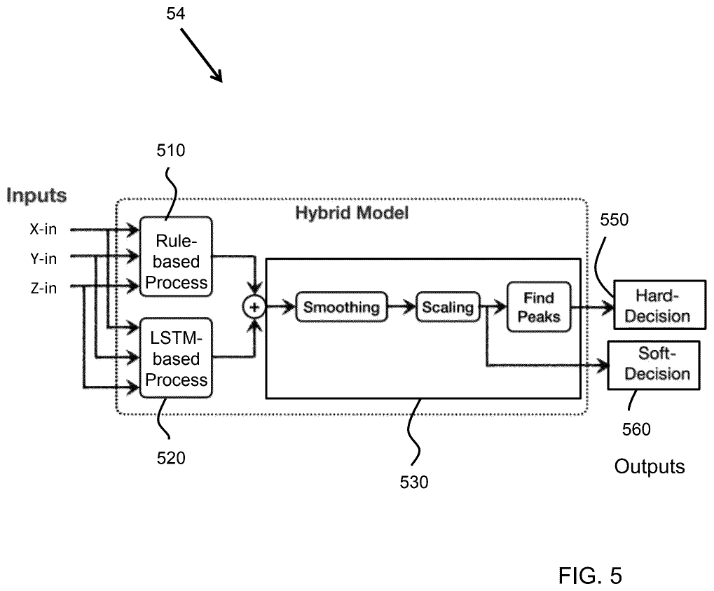

FIG. 5 is a flowchart of a process implemented by such a hybrid model or “hybrid engine” 54 for detecting door-opening and closing events (i.e., implemented by execution of software configured as such an engine). The hybrid ML engine 54 combines two detection processes into an “ensemble.” One detection process of the ensemble is a “rule-based” detection process 510, designed to identify binary features appearing in the input motion sensor signals. In an exemplary embodiment, the rule-based process identifies pulses in the signals exceeding a maximum value within given windows of time (i.e., given periods of time), while also applying additional signal processing filters as described below. The second detection process of the ensemble is an ML model 520 designed as a “Long Short Term Memory” recurrent neural network (LSTM/RNN) process.

Each of the two processes generates its own door-opening and door-closing “predictions” in the form of prediction signals.

Each predication signal represents a likelihood of a door-opening or door-closing event occurring at the given moment of data sampling (according to the pre-set sampling rate).

Such a prediction signal is also referred to herein as a “soft-decision” signal. Soft-decisions signals may be combined into a final hybrid predictive signal, also referred to herein as an “ensemble signal.” The combination may be performed by addition of signal values, typically weighted based on empirically determined confidence scores. The ensemble signal is then processed by an ensemble output filter 530, which includes a smoothing stage (e.g., a 1D Savitzky-Golay filter), followed by min/max scaling, and, finally, a step that generates binary door-open/closing event predictions, indicated as “hard” decisions 550. Hard decisions may be indicated as delta-pulses of zero or one, one representing an event detection (i.e., prediction), zero meaning no event. The controller is configured to output alerts when events are detected. The controller may also record the smoothed/scaled output signal, before the binary conversion, indicated as “soft” decision signal 560. The soft decision signal and other interim signals of the process may be recorded for subsequent analysis and improvement of prediction accuracy.

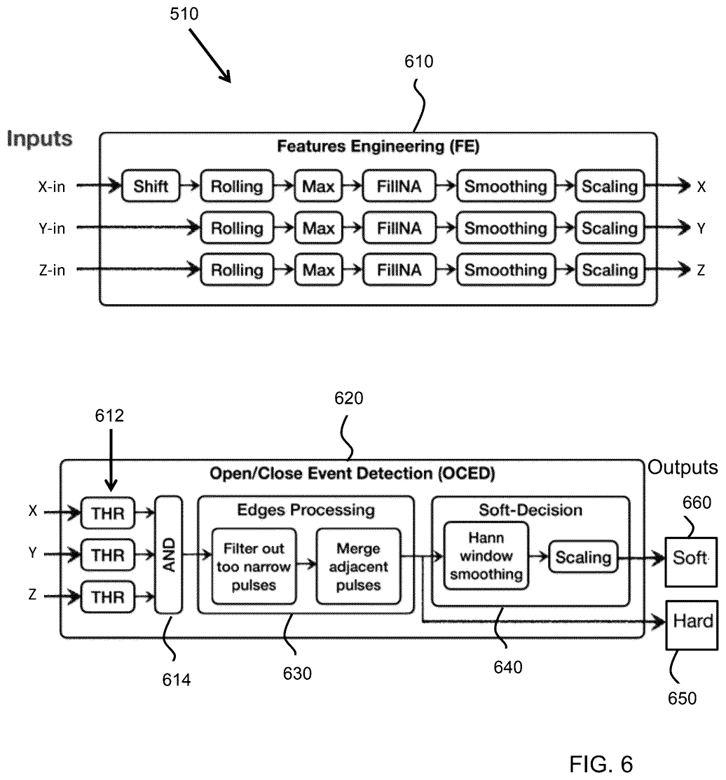

FIG. 6 is a schematic diagram of the rule-based detector process 510 implemented that may be implemented alone or as part of a hybrid machine learning model for detecting door-opening and closing events. The rule-based detection process may include two phases, a feature engineering phase 610, and an event detection phase 620. During the feature engineering phase 610, the process 510 receives input signals such as microphone and/or X, Y, Z accelerometer signals, processing each signal separately, in parallel. As indicated in the figure, the X signal, and/or any other of the signals, may be shifted by one or more periods of sampling, based on an empirical evaluation to improve the final accuracy of the detector.

The first phase 610 may first process each signal by applying a “rolling” filter, which is a window-grouping calculation. The rolling may be following by a “max” function, picking a maximum value within each given window grouping. A “Fillna” function (“Fill NAN Values With Mean,” from the Python library Pandas, where mean values are typically pre-computed during a calibration phase) may then fill missing digital values in the signal, so that signals with complete data per each time increment can be applied to a smoothing function (e.g., a 1D Savitzky-Golay filter, with pre-computed coefficients, to save computation time). Smoothing may be applied to reduce the noise that may be prominent at high frequencies. Smoothing also filters pulses that are too short (meaning they are noise) and merges together adjacent pulses.

The signals that are generated by the first phase 610 may then be applied in the second phase 620 to a threshold filter, at a step 612, to generate respective binary signals, which may then be merged (e.g., added) at a step 614. Post-processing may be applied to the merged signal at a step 630 at which too-narrow pulses are filtered out and adjacent pulses are merged together, generating a hard decision, binary signal output 650, indicative of whether or not an event is predicted at a given sampling moment. Finally, a Hann-window smoothing filter 640 may be applied in a convolution scheme, together with min/max scaling, to generate a soft-decision signal 660 indicative of a level of likelihood of door-opening and door-closing events. (The Hann window coefficients can be pre-computed and stored in flash memory for greater efficiency.)

The first phase output may also be processed by other “shallow” signal processing algorithms to generate features that may be correlated with door opening- and closing-events, that is, trained by correlation methods known in the art. Features may be extracted by methods such as short-time Fourier transform (STFT), Amplitude Envelope Analysis, and wavelet decomposition, where high-frequency wavelets may indicate sudden impacts. In some implementations of the present invention, a rule-based engine incorporating one or more of these algorithms, correlated with door-opening and closing events, is applied in a stand-alone mode without the additional LSTM/RNN process.

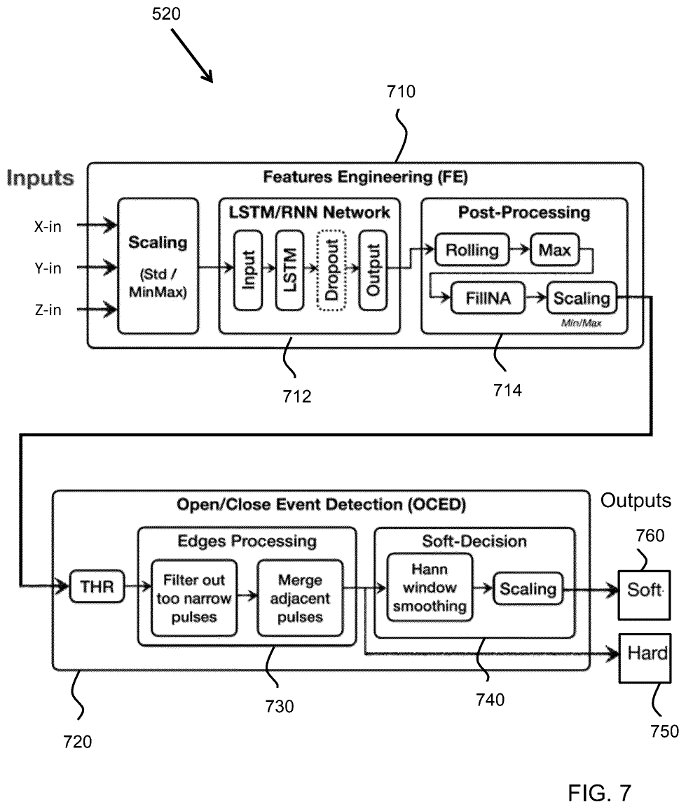

FIG. 7 is a schematic diagram of the LSTM/RNN process 520 described above that may be implemented within the hybrid ML engine for detecting door-opening and closing events. The LSTM/RNN process has a core LSTM/RNN model 712 that, like the rule-based detector process 510 is trained to optimize prediction accuracy as described above with respect to FIG. 3.

The core model 712 typically has, as shown, an input-layer followed by a dropout layer, which may be a single hidden-layer (depth of 1) with Relu (“Rectified Linear Unit”) activation. The output layer may have softmax activation. (For optimal embedded implementation, the LSTM weights may be quantized to 8 or 16 bits depending on accuracy requirements, with weight matrices stored in memory-aligned format for efficient access. The dropout layer may be removed or bypassed during inference to improve processing speed.) The neural-network output may then go through a post-processing stage 714 and event-detection stage 720, similar to the rule-based processing described above. Post-processing may be applied to the merged signal at an edge-processing step 730, at which too-narrow pulses are filtered out and adjacent pulses are merged together, generating hard decision, binary outputs 750, indicative of whether or not an event is predicted at a given sampling moment. Implementation of the filtering may use circular buffers to minimize memory usage and optimize cache performance. Subsequently, a Hann-window smoothing filter 740 may be applied in a convolution scheme, together with min/max scaling, to generate a soft-decision signal 760 indicative of likelihood of door-opening and door-closing events.

Multiple hyper-parameters were tested, for both the rule-based and LSTM-based processes. For the LSTM-based recurrent neural network (RNN), layers with 3-10 neurons were sufficient to provide a high level of accuracy. (The implementation may use vectorized operations where supported by the hardware, with activation functions potentially implemented using lookup tables to improve processing speed.) Other tunable hyperparameters are described in the table provided below. Three type of hyper-parameters are indicated: rule-based, LSTM/RNN and hybrid. Some hyper-parameters were determined through a manual exploration/analysis. Some LSTM/RNN parameters are tuned during the neural-network training. Others were tuned in a grid-search fashion for dominant parameters, thereby providing local optimum solutions. The table below indicates both “dominant” parameter values and near-optimal (“relevant”) ranges.

| | | | | Relevant | Full |
|---|---|---|---|---|---|
| Engine | Parameter | Dominant | Units | Range | Range |
| Rule Based | Rolling window | 130 | Samples | [1, 300] | [1, ∞) |
| | size | | | | |
| model | Accelerometer X | 0.4 | — | [0.1, 0.9] | [0, 1] |
| | threshold | | | | |
| | Accelerometer Y | 0.3 | — | [0.1, 0.9] | [0, 1] |
| | threshold | | | | |
| | Accelerometer Z | 0.5 | — | [0.1, 0.9] | [0, 1] |
| | threshold | | | | |
| | Smoothing | 199 | Samples | [1, 300], | [1, ∞), |
| | window size | | | Odd | odd |
| | Smoothing | 3 | integer | [1, 10] | [1, ∞) |
| | polynomial order | | | | |
| | Minimal events | 30 | Samples | [5, 100] | [1, ∞) |
| | distance | | | | |
| | Merge radius | 700 | Samples | [100, 1500] | [1, ∞) |
| | (adjacent events) | | | | |
| LSTM/RNN | Rolling window | 300 | Samples | [1, 300] | [1, ∞) |
| | size | | | | |
| model | NN hard-decision | 0.28 | — | (0, 1) | (0, 1) |
| | threshold | | | | |
| | Minimal events | 30 | Samples | [5, 100) | [1, ∞) |
| | distance | | | | |
| | Merge radius | 700 | Samples | [100, 1500) | [1, ∞) |
| | (adjacent events) | | | | |
| | Training length | 20 | Epochs | [5, 50) | [1, ∞) |
| | Training batch- | 64 | Samples | [32, 128) | [1, ∞) |
| | size | | | | |
| | Number of neuron | 5 | integer | 1-50 | [1, 00) |
| | cells | | | | |
| | Dropout ratio | 0.5 | ratio | [0, 0.8] | [0, 1] |
| | during training | | | | |
| | Scaling mode | minmax | minmax/ | minmax | minmax/ |
| | | | std | | std |
| Hybrid | LSTM/RNN | 1.0 | | (0.5, 1.0) | (0, ∞) |
| model | derating factor | | | | |
| (ensemble) | Smoothing | 199 | Samples | [49, 399), | [1, ∞), |
| | window size | | | odd | odd |
| | Smoothing | 3 | integer | [1, 10] | [1, ∞) |
| | polynomial order | | | | |
| | Minimal events | 500 | Samples | [50, 1000) | [1, ∞) |
| | distance | | | | |
| | Minimal events | 0.3 | — | [0.1, 0.9] | (0, ∞) |
| | score | | | | |

Accelerometer thresholds are equipment dependent, but may be scaled and applied with no units, the optimal values being determined through manual exploration. That is, threshold values may be extracted in a region that seems reasonable and are then further optimized in a sweep-procedure that seeks a local optimum close to the manually extracted values.

The “minimal events distance” defines the minimal gap between any two adjacent events (open/close). Any two events with a lower distance are merged into a single, joint event. The motivation for joining the events is to eliminate noise that would be caused by misidentifying a single event as multiple events.

The “derating factor” is a multiplication coefficient that adjusts the relative weight of the LSTM/RNN model's contribution to the ensemble prediction. A factor of 1.0 gives the LSTM/RNN model's predictions full weight, while values less than 1.0 reduce its influence relative to the rule-based engine. This allows system designers to tune the balance between the two models based on empirical performance data. For example, in deployments where the rule-based engine shows higher reliability, the derating factor can be set below 1.0 to favor its predictions.

For the Smoothing-Window-Size and the Rolling-Window-Size parameters, higher values typically increase the accuracy but also increase memory/power consumption, as more samples have to be locally stored during the processing. The values shown above as “dominant” were selected as providing a reasonable balance between the accuracy and resource requirements.

It is to be understood that the shallow (e.g., rules-based) model and the deep (e.g., LSTM/RNN) model are orthogonal and can be developed by independent training. Other “deep” models that could also be trained using the data used to train the LSTM/RNN include “temporal convolutional networks” (TCNs). A “shallow” machine learning model that could be trained instead of the rules-based model could be the XGBoost model and its variants.

To optimize power consumption, the implementation can use DMA (Direct Memory Access) for sensor data collection, with processor sleeping between sensor readings. A real-time operating system (RTOS) is generally employed to coordinate sensor readings with processing operations.

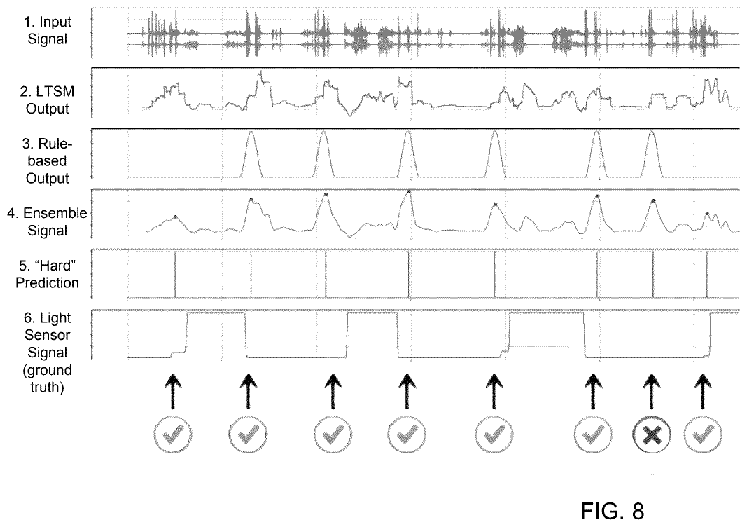

FIG. 8 is a set of graphs of exemplary signals generated during operation of the ML engine process described above, illustrating the system performance for a given input, and across the key system components. The row 1 presents motion sensor (e.g., accelerometer) input signals (X, Y, Z). Rows 2-4 indicate interim signals generated by the system, i.e., the prediction of the separate LSTM and rule-based processes, and the ensemble signal generated by combining the two (“soft”) signals together. Row 5 indicates the overall/final prediction of the hybrid model (the binary “hard” predictions). As indicated, the final predictions are pulses indicating the local maximums of the ensemble signal, in regions where the ensemble signal exceeds a preset threshold. As described above, the predictions correlate door-opening and door-closing events to vibrations in time windows before, during and after those events.

The last row shows the “ground-truth,” the actual door-opening and door-closing events, edges of pulses received during training and testing with the light-sensor detector 404, as described above with respect to FIG. 4B. The arrowed annotation at the bottom of the graph indicates that during the exemplary period of time shown, with 9 actual open/closing events, there were 8 correct predictions (indicated by checks) and 1 false-positive prediction (indicated by an “x”).

To improve accuracy and efficiency (i.e., processing time/power consumption) the system provided binary indications of events, whether they were door-opening or closing events. A similar model can predict opening and closing events separately, though the efficiency is better when the events are predicted together (given that fewer “labels” are required). Additional models that could be merged in an efficient hybrid ML engine could be other known detection models, in addition to those described above, such as models based on Isolation Forest, or autoencoder algorithms. Several popular libraries, such as GridSearch, can assist in the process of sweeping parameters for local optimums.

### Examples

A first example of an embodiment of the invention is a device for monitoring door-opening and door-closing events on a freight container, the device configured to mount on a door of the freight container. The device includes a motion sensor, a communications transmitter; and a processor configured to perform steps that include: receiving motion signals generated by the motion sensor; processing the signals by a signal processing model, such as a trained machine learning (ML) model, trained to identify door-opening and door-closing events; responsively identifying likely door-opening or door-closing events; and responsively to identification of a likely door-opening or door-closing events, transmitting an alert by the communications transmitter indicating the event.

A second example includes the features of the first example and the motion sensor is either a 3-axis accelerometer or a microphone. In an example 3, the motion sensor is both a 3-axis accelerometer and a microphone.

An example 4 includes features of any of the above examples and training the ML model comprises supervised training comparing a light sensor indication of door-opening and door-closing events with motion signals generated by the motion sensor during a training period.

An example 5 includes features of any of the above examples and the ML model is trained as an ensemble predictive model, composed of two or more models, one model being a rule-based model identifying features within each increment of a preset duration of time, and a second model being a neural network (NN) model trained to identify door-opening and door-closing events.

An example 6 includes features of example 5 and the rule-based model is tuned to identify maximum motion values

An example 7 includes features of either of claims 5-6, and the rule-based model and the NN model generate soft decision signals that are added, smoothed, and scaled, and the peaks are identified to identify the likely door-opening and door-closing events.

An example 8 includes features of any of claims 5-7, and the NN model is a “Long Short Term Memory” recurrent neural network (LSTM/RNN) process.

An example 9 includes features of any of examples 5-9, and the processor is further configured to perform steps that: create a first prediction signal using the rule-based model; create a second prediction signal using the neural network model; combine these prediction signals to generate an ensemble signal; and apply filtering to the ensemble signal to generate binary predictions of door events.

An example 10 includes features of examples 5-9, where signal processing includes: applying a rolling filter to motion signals from each axis of the motion sensor to create filtered signals; finding maximum values within time windows of these filtered signals; applying smoothing to the filtered signals; applying threshold filtering to generate binary signals; and combining the binary signals to generate event predictions. Example 11 expands on the threshold filtering by defining upper and lower thresholds to create a hysteresis band, transitioning between states based on these thresholds, and maintaining the previous state when signals fall between thresholds.

An example 12 includes features of any of examples 1-11, where signal processing further includes: correlating characteristic signal patterns that precede door-opening and door-closing events in a first window of time to the likelihood of door events, wherein the characteristic signal patterns include vibrations indicative of moving locking handles. An example 13 further includes correlating secondary vibration patterns in a second time window occurring after the door events with the characteristic signal patterns from the first window of time; and further adjusting the likelihood of door events based on the correlation between the characteristic signal patterns and the secondary vibration patterns.

An example 14 of the present invention is a method for monitoring door-opening and door-closing events on a freight container. The method includes generating motion signals at a motion sensor internal to a monitoring device mounted on the freight container, while at a processor internal to the monitoring device, receiving and processing the motion signals from the motion sensor. Processing the motion signals includes using a trained machine learning model that is trained to identify door-opening and door-closing events, and responsively identifying likely door-opening or door-closing events based on the processing. Upon identification of a likely door-opening or door-closing event, the processor may transmit, via a communications transmitter of the monitoring device, an alert indicating the event.

Further examples of the present invention include methods for identifying door-opening and door-closing events as implemented according to any of the above examples.

While the invention has been described with respect to a limited number of embodiments, these should not be construed as limitations on the scope of the invention, but rather as exemplifications of some of the preferred embodiments as defined by the claims. That is, the scope of the present invention includes variations and modifications thereof which would occur to persons skilled in the art upon reading the foregoing description and which are not disclosed in the prior art.

1. A device for monitoring door-opening and door-closing events on a freight container comprising:
a motion sensor;
a communications transmitter; and
a processor having non-transient memory including instructions that when executed perform:
receiving motion signals generated by the motion sensor;
processing the signals by a signal processing model having prior training to identify door-opening and door-closing events;
responsively identifying likely door-opening or door-closing events;
responsively to identification of a likely door-opening or door-closing event, transmitting an alert indicating the event.

2. The device of claim 1, wherein the motion sensor comprises a microphone.

3. The device of claim 3, wherein the motion sensor comprises both a 3-axis accelerometer and a microphone.

4. The device of claim 1, wherein the prior training of the signal processing model included supervised training comparing a light sensor indication of door-opening and door-closing events with motion signals generated by the motion sensor.

5. The device of claim 1, wherein the signal processing model is trained as an ensemble predictive model, composed of two or more models, one model being a rule-based model identifying features within each increment of a preset duration of time, and a second model being a neural network (NN) model trained to identify door-opening and door-closing events.

6. The device of claim 5, wherein the rule-based model is tuned to identify maximum motion values.

7. The device of claim 5, wherein the rule-based model and the NN model generate soft decision signals that are added, smoothed, and scaled, and wherein the peaks are identified to identify the likely door-opening and door-closing events.

8. The device of claim 5, wherein the NN model is a “Long Short Term Memory” recurrent neural network (LSTM/RNN) process.

9. The device of claim 5, wherein the processor is further configured to:
generate a first prediction signal from the rule-based model;
generate a second prediction signal from the neural network model;
combine the first prediction signal and the second prediction signal to create an ensemble signal; and
apply an ensemble output filter to the ensemble signal to generate binary door event predictions.

10. The device of claim 5, wherein the processor is further configured to implement steps of:
applying a rolling filter to motion signals from each axis of the motion sensor to generate filtered signals;
determining maximum values within time windows of the filtered signals;
applying smoothing to the filtered signals;
applying threshold filtering to generate binary signals; and
merging the binary signals to generate event predictions.

11. The device of claim 10, wherein applying threshold filtering comprises: defining an upper threshold and a lower threshold to create a hysteresis band; transitioning from a low state to a high state when a filtered signal exceeds the upper threshold; transitioning from the high state to the low state when the filtered signal falls below the lower threshold; and maintaining a previous state when the filtered signal is between the upper threshold and the lower threshold.

12. The device of claim 1, wherein processing the signals comprises correlating characteristic signal patterns that precede door-opening and door-closing events in a first window of time to the likelihood of door events, wherein the characteristic signal patterns include vibrations indicative of moving locking handles.

13. The device of claim 12, wherein processing the signals further comprises: correlating secondary vibration patterns in a second time window occurring after the door events with the characteristic signal patterns from the first window of time; and further adjusting the likelihood of door events based on the correlation between the characteristic signal patterns and the secondary vibration patterns.

14. The device of claim 1, wherein the device is configured to mount on a door of the freight container.

15. A method for monitoring door-opening and door-closing events on a freight container, the method comprising:
at a motion sensor internal to a monitoring device mounted on a door of the freight container, generating motion signals;
at a processor internal to the monitoring device:
receiving the motion signals from the motion sensor;
processing the motion signals by a trained machine learning (ML) model trained to correlate door-opening and door-closing events with container door vibrations to identify a likely door-opening or door-closing event, and
transmitting, via a communications transmitter of the monitoring device, an alert indicating the event.

16. The method of claim 15, wherein the motion sensor comprises both a 3-axis accelerometer and a microphone.

17. The method of claim 16, wherein the ML model is trained as an ensemble predictive model, composed of two or more models, one model being a rule-based model identifying features within each increment of a preset duration of time, and a second model being a neural network (NN) model trained to identify door-opening and door-closing events.

18. The method of claim 16, wherein the training of the ML model is generated by supervised training comparing a light sensor indication of door-opening and door-closing events with motion signals generated by the motion sensor during a training period.

19. The method of claim 16, wherein processing the signals comprises correlating characteristic signal patterns that precede door-opening and door-closing events in a first window of time to the likelihood of door events, wherein the characteristic signal patterns include vibrations indicative of moving locking handles.

20. The method of claim 19, wherein processing the signals further comprises: correlating secondary vibration patterns in a second time window occurring after the door events with the characteristic signal patterns from the first window of time; and further adjusting the likelihood of door events based on the correlation between the characteristic signal patterns and the secondary vibration patterns.
